(19) United States
(12) Patent Application Publication
(10) Pub. No.: US 2026/0266866 A1
(43) Pub. Date: Sep. 10, 2026

(54) ACCELEROMETER WITH PROOF MASS BONDING FEATURE

(71) Applicant: Honeywell International Inc., Charlotte, NC (US)

(72) Inventor: Christina A. Polwarth, Redmond, WA (US)

(21) Appl. No.: 19/074,141

(22) Filed: Mar. 7, 2025

(51) Int. Cl. G01P 15/097; G01P 15/08

(52) U.S. Cl. CPC G01P 15/097; G01P 15/0802; G01P 2015/0828

(57) ABSTRACT

In one example, this disclosure describes a proof mass assembly comprising: a proof mass element; and a resonator, wherein the resonator is bonded directed to the proof mass element, wherein the proof mass element has a first coefficient of thermal expansion (CTE), wherein resonator has a second CTE, and wherein a bond between the resonator and the proof mass element has a third CTE, the third CTE being substantially similar to or of lower magnitude than one or more of the first CTE or the second CTE.

### TECHNICAL FIELD

This disclosure relates to accelerometers.

### BACKGROUND

Accelerometers function by detecting a displacement of a proof mass under inertial forces. One technique of detecting force and acceleration is to measure the displacement of the mass relative to a frame. Another technique is to measure the stress induced in resonators as they counteract inertial forces of the proof mass. The stress may, for example, be determined by measuring the change in the frequencies of the resonators as the accelerometer is subjected to an outside force.

### SUMMARY

In general, the disclosure is directed to devices, systems, and techniques for reducing bias within an accelerometer system (e.g., within an accelerometer system containing a flexure accelerometer). Within the accelerometer, vibrating resonator(s) are bonded to a proof mass element. This bonded assembly may be in contact with or bonded to additional surfaces. In some examples, where the resonators, proof mass element, and non-moving members(s) are bonded by an adhesive with a larger coefficient of thermal expansion (CTE) than that of the structural materials, the adhesive bond(s) may expand and/or contract at higher rates than the resonators, proof mass elements, or the non-moving member(s) when exposed to changes in temperature. The different ranges of expansion and/or contraction may induce a strain at or around interface(s) between the proof mass element and the non-moving member(s). The induced strain may lead to a bias in the accelerometer system and be mis-interpreted as signals indicating a change in the acceleration applied on the accelerometer; this would reduce the accuracy of acceleration values outputted by the accelerometer system.

This disclosure describes devices, systems, and techniques for reducing the CTE value of the bond(s) existing between the proof mass element and one or more elements coupled to the proof mass element. The one or more elements may include, but are not limited to, non-moving member(s) or resonators (e.g., within a vibrating beam accelerometer). In some examples, a bond is formed between the proof mass element and each of the one or more elements to secure the proof mass element to the one or more elements. The bond will have a CTE value either equivalent to or of lower magnitude than either or both a first CTE value of the proof mass element and a second CTE value of one or more elements. The reduction in the bond CTE value(s) may reduce thermally induced strain at interfaces between the proof mass and the one or more elements, thereby reducing bias in the accelerometer system and improving the accuracy of the output by the accelerometer system.

The bonding method used may also form an improved bond between the proof mass element and the one or more elements. For example, the bonding method may form a bond only between selectively damaged regions of the proof mass element and one of the one or more elements. The bonding method may allow for a thinner bond length than achievable with conventional techniques, e.g. solder, epoxy, which may reduce an amount of stress applied to the proof mass element and the respective element of the one or more elements to form the bond. This reduced bond length may reduce bias in the accelerometer system due to the stress on the proof mass and/or the non-moving member(s).

In some examples, this disclosure describes a proof mass assembly comprising: a proof mass element; and a resonator, wherein the resonator is bonded directed to the proof mass element, wherein the proof mass element has a first coefficient of thermal expansion (CTE), wherein resonator has a second CTE, and wherein a bond between the resonator and the proof mass element has a third CTE, the third CTE being substantially similar to or of lower magnitude than one or more of the first CTE or the second CTE.

In some examples, this disclosure describes a method comprising: selective damaging, via one or more of an ultra-fast laser or ion implantation, a first outer surface of a first component of a proof mass assembly and a second outer surface of a second component of the proof mass assembly to selective damage a first lattice of the first component and a second lattice of the second component; disposing a bonding solution over the first outer surface and the second outer surface, wherein the bonding solution comprises a hydroxide and one or more additives; placing the first outer surface in contact with the second outer surface; and forming, via the one or more additives in the bonding solution, a bond between a first selectively damaged portion of the first lattice and a second selectively damaged portion of the second lattice, wherein the first element has a first coefficient of thermal expansion (CTE), wherein the second element has a second CTE, wherein the bond has a third CTE, and wherein the third CTE is less than or equal to one or more of the first CTE or the second CTE.

In some examples, this disclosure describes a proof mass assembly comprising: a proof mass element comprising: a proof mass movable portion; and a proof mass support coupled to the proof mass movable portion; and a resonator extending from a first end to a second end; wherein the first end of the resonator is bonded directly to the proof mass movable portion via a first bond, wherein the second end of the resonator is bonded directly to the proof mass support via the second bond, wherein the proof mass element has a first coefficient of thermal expansion (CTE), wherein the resonator has a second CTE, and wherein the each of the first bond and the second bond has a third CTE, the third CTE being less than or equal to one or more of the first CTE or the second CTE.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a conceptual diagram illustrating an exploded view of an example accelerometer system, in accordance with one or more techniques of this disclosure.

FIG. 2 is a conceptual diagram illustrating a top view of the example proof mass of the accelerometer system of FIG. 1.

FIG. 3 is a conceptual diagram illustrating a side view of a bond between a proof mass element and one or more elements of FIG. 2.

FIG. 4 is a conceptual diagram illustrating a cross-sectional view of the bond of FIG. 3, the cross-section being take along a longitudinal axis of the accelerometer system.

FIG. 5 is a conceptual diagram illustrating an example chemical structural diagram at the bond of FIG. 3.

FIG. 6 is a flowchart illustrating an example technique for bonding two or more elements within the accelerometer system of FIG. 1.

Like reference characters denote like elements throughout the description and figures.

### DETAILED DESCRIPTION

Navigation systems and positioning systems rely on the accuracy of accelerometers, such as vibrating beam accelerometers (VBAs) to perform critical operations in various environments. VBAs use a proof mass assembly including resonators (e.g., vibrating beams, double-ended tuning forks, or the like) to measure acceleration. For example, a resonator may determine the displacement of a proof mass with a high degree of accuracy from which an acceleration experienced by the VBA may be determined. Resonators utilizing beams (alternatively referred to herein as “tines”) made of a piezo-electric material use electrodes on surfaces of the beams to drive the piezo-electric beams into resonance. For example, opposing surfaces of the resonator beams may have electrodes configured to have opposite charges spatially aligned across from each other.

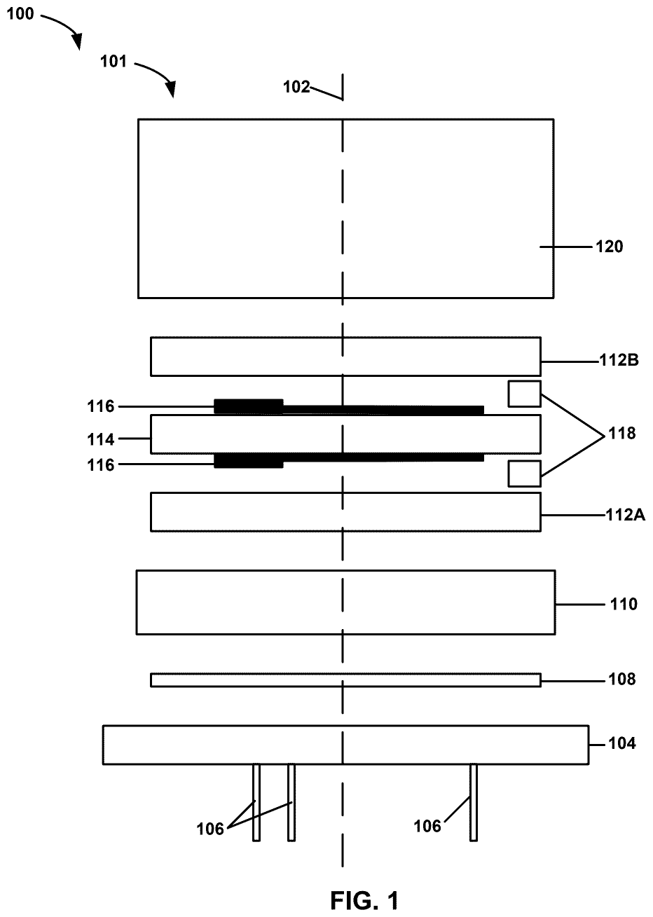

FIG. 1 is a conceptual diagram illustrating an exploded view of an example accelerometer system 100, in accordance with one or more techniques of this disclosure. Example accelerometer system 100 (alternatively referred to herein as “system 100”) may include, but is not limited to, a VBA 101. In some examples, system 100 includes one or more other types of accelerometers.

VBA 101 may include, but is not limited to, a base 104 (alternatively referred to herein as “header 104”), electrical connector(s) 106 extending from base 104, circuitry 108, isolator 110, dampening plates 112A-112B (collectively referred to herein as “dampening plates 112”), proof mass element 114, resonators 116, spacers 118, and housing 120 (alternatively referred to herein as “can 120”). The components of VBA 101 may be arranged along a sensing axis 102 of VBA 101. Sensing axis 102 may extend from a proximal end of VBA 101 (e.g., a proximal end of base 104) to a distal end of VBA 101 (e.g., a distal end of housing 120).

Base 104 of VBA 101 may connect VBA 101 to an object. Base 104 may include one or more openings and/or recesses, each configured to receive a fastener or other fixation element. Base 104 may include one or more channels extending through base 104 (e.g., along sensing axis 102). The one or more channels may be configured to receive connector(s) 106 extending from circuitry 108 and out of VBA 101.

Connector(s) 106 may be electrically coupled to circuitry 108 and electrically isolated from base 104. Connector(s) 106 allow for the travel of electrical signals into and out of VBA 101. Circuitry 108 may be electrically coupled to resonators 116 and may direct electrical current into resonators 116 and/or receive electrical signals from resonators 116. Circuitry 108 may direct electrical signals into and out of VBA 101 (e.g., into processor(s) or processing circuitry of system 100) through corresponding connector(s) 106.

VBA 101 may include a proof mass assembly. The proof mass assembly may include a proof mass element 114 disposed between dampening plates 112 along sensing axis 102. The proof mass assembly may further include resonators 116 affixed to surfaces of proof mass element 114. Spacers 118 within the proof mass assembly may be disposed between dampening plates 112 and proof mass element 114 and define gaps between dampening plates 112 and proof mass element 114. Resonators 116 may be disposed within the gaps on either side of proof mass element 114.

Resonators 116 may be bonded to surfaces of proof mass element 114 via an hydroxide-catalyzed bond (not pictured in FIG. 1). The hydroxide-catalyzed bond may form between one surface of each resonator 116 and a corresponding surface on proof mass element 114 (e.g., between a first damaged lattice on a first surface of resonator 116 and a second damaged lattice on a second surface of proof mass element 114).

Other VBAs may affix resonators to proof mass elements via an adhesive (e.g., epoxy), which have a larger CTE than the resonators and/or proof mass elements. When the other VBAs experience a change in temperature, the adhesive may expand and/or contract at a higher rate than the resonators and proof mass element due to the difference in CTE, thereby inducing a strain along interfaces between resonators and the proof mass element. The induced strain may create a bias in the sensed signals from the VBA, e.g., thereby reducing an accuracy of the VBA.

The hydroxide-catalyzed bonding mechanism used between resonators 116 and proof mass element 114 may form bonds between resonators 116 and proof mass element 114 to affix resonators 116 to proof mass element 114. The hydroxide-catalyzed bond may define a CTE similar to or less in magnitude than one or more of resonators 116, proof mass element 114, spacers 118, and/or damping plates 112. In such examples, the hydroxide-catalyzed bond may reduce the CTE of the bond across interfaces between resonators 116 and proof mass element 114, or between proof mass element 114 and spacers 118, or between proof mass element 114 and damping plates 112, or between damping plates 112 and spacers 118, e.g., thereby reducing bias in VBA 101 and increasing the accuracy of VBA 101 and of system 100. The bond may consist of hydroxide-catalyzed hydration and dehydration mechanisms, wherein a bonding solution containing both hydroxide and silicate is applied to a surface with regions of selectively damaged crystal lattices. The adjoining material surface will also exhibit selective damage to the crystal lattice at the bonding region(s) of interest. The damaged regions intended for bonding are placed in contact with each other to create a chemical bond. Additionally, pressure and temperature may be applied to the materials to be bonded to improve the bond.

A manufacturing assembly may selectively damage lattices along surfaces of resonators 116 and proof mass element 114 via an ultra-short pulse laser and/or via ion implantation. The manufacturing assembly may then dispose a bonding solution over the surfaces of resonators 116 and proof mass element 114 (e.g., over the damaged lattices of resonators 116 and proof mass element 114). Chemicals within the bonding solution (e.g., an Alkali solution within the bonding solution) may etch the damaged lattices at a faster rate than other portions of the surfaces of resonators 116 and proof mass element 114, e.g., causing selective damage to the lattices along the surfaces of resonators 116 and proof mass element 114. The bonding solution may facilitate the formation of bonds between atoms on the selectively damaged lattices of resonators 116 and proof mass element 114, e.g., to bond resonators 116 directly to proof mass element 114.

Dampening plates 112 are connected to proof mass element 114 via spacers 118. Dampening plates 112 may be connected to spacers 118, e.g., via a hydroxide-catalyzed bonding, a bond formed via silicates within the bonding solution, via a brazing material, via a solder material, or via an epoxy. Spacers 118 may define a gap along sensing axis 102 between each dampening plate 112 and proof mass element 114. The gap may be sized to allow for movement of proof mass element 114 and/or resonators 116 in response to VBA 101 experiencing an acceleration along sensing axis 102. In some examples, spacer 118 is integral to proof mass element 114 and/or to dampening plates 112. Dampening plates 112 may limit a range of rotation, motion, and/or displacement of proof mass element 114 within VBA 101. Dampening plates 112 may at least partially thermally insulate proof mass element 114.

Proof mass element 114 may include an inner movable portion (alternatively referred to herein as the “proof mass movable portion”) and an outer rigid portion (alternatively referred to herein as the “proof mass support”). The proof mass support may define a frame of proof mass element 114. Each of resonators 116 may have opposite ends attached to proof mass movable portion and the proof mass support, respectively.

Each of resonators 116 may vibrate at a certain frequency based on the geometry of resonators 116 and/or material properties (e.g., density, elastic modulus) of resonator 116. Circuitry 108 may transmit electrical signals to each resonator 116 to induce vibrations within resonators 116 (e.g., due to the piezo-electric properties of materials forming resonators 116). Resonators 116 may change vibrational frequencies in response to the application of forces of resonators 116. When VBA 101 experiences acceleration, a portion of proof mass element 114 (e.g., the proof mass movable portion of proof mass element 114) may deflect relative to the proof mass support, e.g., along sensing axis 102. The deflection of the proof mass movable portion may induce axial tension along one of resonators 116 and axial compression along the other of resonators 116, thereby altering the vibrational frequencies of resonators 116.

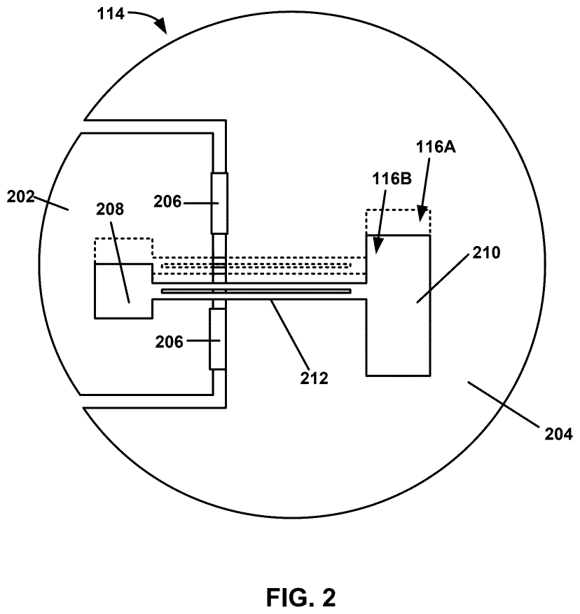

FIG. 2 is a conceptual diagram illustrating a top view of proof mass element 114 of system 100 of FIG. 1. As illustrated in FIG. 2, proof mass element 114 may include a proof mass movable portion 202, a proof mass support 204, and hinge(s) 206 connecting proof mass movable portion 202 to proof mass support 204. Resonators 116A, 116B (collectively referred to herein as “resonators 116”) are affixed to opposite surfaces of proof mass element 114. Each of resonators 116 may include a first end 208 coupled to proof mass movable portion 202, a second end 210 coupled to proof mass support 204, and a bridge 212 connecting first end 208 to second end 210. Proof mass movable portion 202, proof mass support 204 and/or hinge(s) 206 may be formed from a quartz, a fused silica, or one or more other materials capable of forming a covalent bond with Silicon. The one or more other materials may include, but is not limited to, silica with a surface oxide layer, a lithium-aluminosilicate glass-ceramic, an ultra-low thermal expansion coefficient (ULE) glass, a borosilicate, one or more silica-based or silica-containing materials).

Resonators 116 may be affixed to proof mass element 114 via a bond (e.g., a hydroxide-catalyzed bond). The bond may be between selectively damaged surfaces of resonators 116 and corresponding selectively damaged surfaces of proof mass movable portion 202 and/or proof mass support 204. For example, a bonding solution containing hydroxide and a silicate is applied to one or more of the selectively damage surfaces of resonators 116, proof mass movable portion 202, and/or proof mass support 204. The corresponding selectively damaged surfaces are then placed in contact to form the bond. The bond may have a CTE value equal to or less than the CTE values of resonators 116 and/or of proof mass element 114. In such examples, bond formed may exhibit a lower CTE than resonators 116 and/or proof mass element 114, which may reduce strain at or around interfaces between resonators 116 and proof mass element 114, e.g., thereby reducing bias induced by strain along the interfaces due to CTE mismatch. The silicate may include, but is not limited to, silicon dioxide (SiO₂).

Proof mass element 114 may extend along a reference plane. For example, proof mass movable portion 202, proof mass support 204, and hinge(s) 206 may extend along the reference plane. When proof mass element is disposed within VBA 101, the reference plane is orthogonal to sensing axis 102 (not picture in FIG. 2). Each of resonators 116 may also extend from first end 208 to second end 210 along an axis parallel to the reference plane. When proof mass element 114 is disposed within VBA 100, each of resonators 116 may be disposed along the axis and orthogonal to sensing axis 102.

Proof mass element 114 may be formed from an optically transparent material, e.g., a crystalline quartz. Proof mass movable portion 202, proof mass support 204, and hinge(s) 206 may be formed from the same optically transparent material, e.g., monolithically from the same material. In some examples, one or more of proof mass movable portion 202, proof mass support 204, or hinge(s) 206 may be formed separately and subsequently attached together.

Resonators 116 may be formed from a piezoelectric material including, but is not limited to, quartz (SiO₂), Berlinite (AlPO₄), barium titanate (BaTiO₃), or aluminum nitride (AlN). Resonators 116 may be monolithically formed with proof mass element 114 and may be formed from a same or different material as proof mass element 114. In some examples, where resonators 116 and proof mass element 114 are made of the same material, the adhesive described herein may be disposed between resonators 116 and proof mass element 114 may reduce and/or eliminate a difference in CTE values, e.g., compared to other adhesives such as epoxy.

First end 208 and second end 210 of each resonator 116 may be connected by two elongated tines defining bridge 212. The two elongated tines may extend parallel to each other along a longitudinal axis of resonator 116. In some examples, resonator 116 may have a different number of elongated tines defining bridge 212 (e.g., a single elongated tine, three or more elongated tines). The elongated tines defining bridge may or may not be parallel to each other or to the reference plane of proof mass element 114.

Resonators 116 may be mounted on opposite surfaces of proof mass element 114. For example, resonator 116A may be mounted on a top surface of proof mass element 114 and resonator 116B may be mounted on a bottom surface of proof mass element 114. Resonators 116 may be offset from each other, e.g., relative to a center line of proof mass element 114. Resonators 116A and 116B may be configured to receive opposite axial compressive/tensile forces in response to movement of proof mass movable portion 202 about hinge(s) 206 and relative to proof mass support 204. For example, in response to proof mass movable portion 202 moving in an upward direction relative to proof mass support 204, resonator 116A may receive an axial compressive force and resonator 116B may receive an axial tensile force. In another example, in response to proof mass movable portion 202 moving in a downward direction relative to proof mass support 204, resonator 116A may receive an axial tensile force and resonator 116B may receive an axial compressive force. In this manner, the difference in vibration frequencies of resonators 116 in response to the compressive/tensile forces may be used by processors and/or processing circuitry of the accelerometer system to determine the direction (e.g., along sensing axis 102) and magnitude of the acceleration experienced by VBA 100.

The dimensions of proof mass element 114 and/or of resonators 116 may be selected to configure proof mass element 114 and/or resonators 116 for a specific acceleration range. For example, the dimensions of proof mass movable portion 202 and/or of elongated tine(s) defining bridge 212 may vary based on the intended acceleration range the proof mass assembly containing proof mass element 114 and resonators 116 is configured to sense within.

Proof mass element 114 may include electrical contacts and/or signal traces (not pictured) extending along the surfaces (e.g., the upper and lower surfaces) of proof mass element 114. The electrical contacts and/or signal traces may electrically couple each resonator 116 with a respective protrusion on the outer perimeter of proof mass element 114 (e.g., on proof mass support 204). The electrical contacts and/or signal traces may transmit an electrical signal (e.g., a drive signal) from circuitry 108 of VBA 100 into resonators 116 to cause resonators 116 to vibrate. The electrical contacts and/or signal traces may also transmit electrical signals from resonators 116 to circuitry 108 and processors and/or processing circuitry of the accelerometer system. The electrical signals from resonators 116 may be used to determine the changes in vibration frequencies of resonators 116 and, by extension, the direction and magnitude of the acceleration experienced by VBA 100.

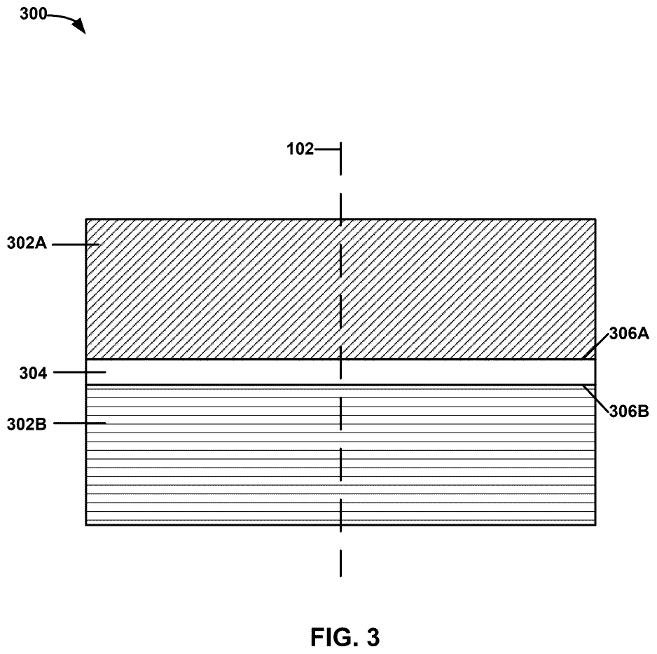

FIG. 3 is a conceptual diagram illustrating a side view of a bond 300 between a first element 302A of proof mass element 114 and a second element 302B of resonators 116. Bond 300 may be a hydroxide-catalyzed bond. Elements 302A, 302B may be collectively referred to herein as “elements 302”. Element 302A may include, but is not limited to, a portion of proof mass movable element 202 or a portion of proof mass support 204. Element 302B may include, but is not limited to, a portion of first end 208 of resonator 116 or a portion of second end 210 of resonator 116. In some examples, bond 300 is between proof mass movable element 202 and first end 208 of resonator 116. In some examples, bond 300 is between proof mass support 204 and of second end 210 of resonator 116. A thickness of bond 300 (e.g., along longitudinal axis 102) may be about 100 nanometers (nm).

A manufacturing assembly may selectively damage lattices of the materials forming elements 302A, 302B along surfaces 306A, 306B, respectively. The manufacturing assembly may selectively damage the lattices via an ultra-fast laser, via ion implantation, or the like. The selectively damaged portions of the lattices may be exposed along surfaces 306A, 306B

Bonding solution 304 may be disposed between element 302A and element 302B. For example, bonding solution 304 may be disposed on one or more of surface 306A of element 302A and surface 306B of element 302B. Surfaces 306A, 306B may be collectively referred to herein as “surfaces 306”. Bonding solution 304 may include, hydroxide and one or more additives. The one or more additives may include, but is not limited to, a silicate (e.g., SiO₂).

Bonding solution 304 may interact with materials forming elements 302A and 302B to further damage the selectively damaged portions of the lattices of elements 302 along surfaces 306. The manufacturing assembly may dispose bonding solution 304 over at least a portion or an entirety of each of surfaces 306. When disposed on surfaces 306, bonding solution 304 may chemically damage surfaces 306, e.g., via an Alkali solution within bonding solution 304. Bonding solution 304 may chemically damage the selectively damaged portions of the lattices of elements 302 (e.g., by the ultra-fast laser, the ion implantation, or the like) at a faster rate than the undamaged portions of the lattices along surfaces 306. In such examples, portions of the lattices of elements 302 previously damaged by the manufacturing assembly may be chemically damaged at a faster rate than surrounding portions of elements 302 and/or may experience a greater magnitude of chemical damage than the surrounding portions of element 302 within a given time period after disposal of bonding solution 304.

Bonding solution 304 may, in response to application of heat and/or pressure (e.g., by the manufacturing assembly), form bond 300 between elements 302A and 302B, e.g., via the one or more additives in bonding solution 304. The additive(s) in bonding solution 304 may interact with the exposed lattices (e.g., the selectively damaged portions of the lattices) of elements 302A and 302B to form bond 300 between elements 302A and 302B. Bond 300 may include a hydroxide-catalyzed bond such as, but is not limited to a Silicon-Oxygen bond such as a Si—O—Si bond, a Si—O—Al bond, or the like.

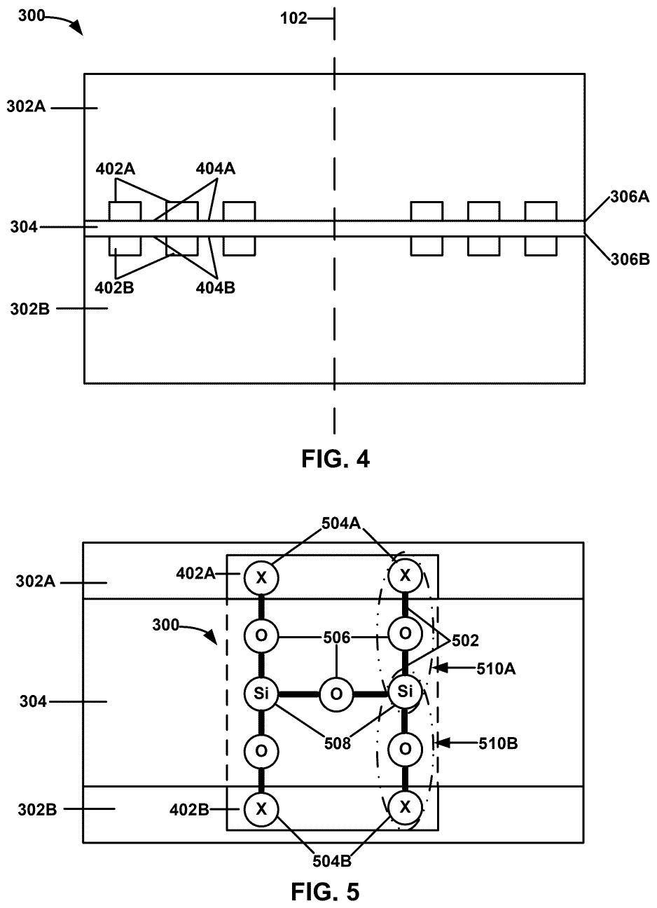

FIG. 4 is a conceptual diagram illustrating a cross-sectional view of bond 300 of FIG. 3, the cross-section being take along a sensing axis 102 of system 100. In some examples, as illustrated in FIG. 4, at least a part of surfaces 306 of elements 302 may be selectively damaged to expose lattices 402A, 402B (collectively referred to herein as “lattices 402”) of elements 302A, 302B, respectively. A manufacturing assembly may selectively damage surfaces 306 via one or more techniques including, but not limited to, application of an ultra-fast laser or ion implantation to selected portions of surfaces 306. Lattices 402 may be selectively damaged, e.g., in response to the application of the ultra-fast laser or ion implantation.

The manufacturing assembly dispose bonding solution 304 onto surfaces 306. Bonding solution 304 may further selectively damage lattices 402A along surfaces 306. Parts 404A, 404B (collectively referred to herein as “parts 404”) of elements 302A, 302B, respectively, may be undamaged prior to disposal of bonding solution 304, e.g., by the ultra-fast laser. When lattices 402 and parts 404 are exposed to bonding solution 304, bonding solution 304 (e.g., a hydroxide or alkali solution within bonding solution 304) may chemically damage lattices 402 at a faster rate and/or to a greater magnitude than parts 404. The chemical damage to lattices 402 may expose atoms of lattices 402, which may allow for the formation of bond 300 between lattices 402 (e.g., between the atoms lattice 402A and atoms lattice 402B), e.g., via additive(s) (e.g., silicates) in bonding solution 304. For example, atoms of lattice 402A may form a first bond with silicates in bonding solution 304 and atoms of lattice 402B may form a second sub-bond with the silicates in bonding solution 304. Together, the first and second sub-bonds may define bond 300. Bond 300 may be directly between surfaces 306, e.g., without any adhesives.

FIG. 5 is a conceptual diagram illustrating an example chemical structural diagram of bond 300 of FIG. 3. As illustrated in FIG. 5, atoms 504A of lattice 402A of element 302A may be exposed along surface 306A (e.g., via selective damage of surface 306A of element 302A). Similarly, atoms 504B of lattice 402B of element 302B may be along surface 306B (e.g., via selective damage of surface 306B of element 302B). Atoms 504A may be of the same or different element than atoms 504B. For example, atoms 504A, 504B may all be Silicon (Si) atoms. In another example, one or more of atoms 504A, 504B may be another element different from Si including, but is not limited to, Aluminum (Al).

Bonding solution 304 may include a plurality of oxygen (O) atoms 506 and atoms 508. Atoms 508 may be of a same or different element than atoms 504A and/or 504B. Atoms 508 may be, but is not limited to, Si atoms. Atoms 506 and 508 may be affixed together within a molecular structure by bonds 502. Bonds 502 may include, but are not limited to Si—O bonds. Atoms 506, 508 may be a part of additive(s) in bonding solution 304.

When elements 302 are placed in contact with each other (e.g., when surfaces 306 of elements 302 are placed in contact with each other) with bonding solution 304 disposed over surfaces 306, additive(s) in bonding solution 304 may form a first bond 510A with element 302A and a second bond 510B with bond 302B. Bonds 510A, 510B (collectively referred to herein as “bonds 510”) may share a common atom 508 (e.g., a common Si atom). Bonds 510 may secure element 302A to element 302B (e.g., secure resonators 116 to proof mass movable element 202 and/or proof mass support 204). Each of bonds 510 may be a covalent bond.

Each of bonds 510 may include atoms 504 coupled to atoms 506 and/or 508 via bonds 502. For example, as illustrated in FIG. 5, atoms 504A of lattice 402A of element 302A may be coupled to atoms 506 via bonds 502. The respective atoms 506 may be coupled to atoms 508 via other bonds 502. In conjunction, one atom 504A, one atom 506, one atom 508, and the interconnecting bonds 502 may define bond 510A. In another example, one atom 504B of lattice 402B of element 302B, one atom 506, one atom 508, and the interconnecting bonds 502 may define bond 510B. Bonds 510 may be of a same or different type. One or more of bonds 510 may be a Si—O—Si bond, or the like.

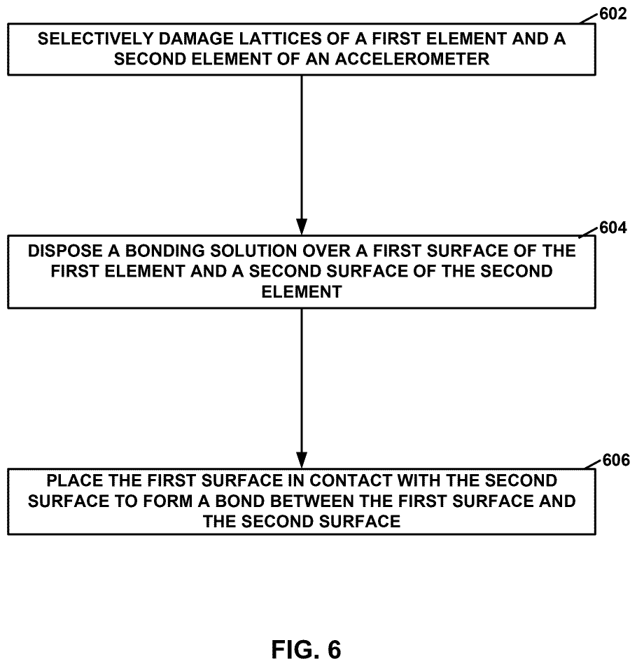

FIG. 6 is a flowchart illustrating an example technique for affixing two or more elements within system 100 of FIG. 1. The example technique described herein may be used to affix resonators 116 of system 100 to proof mass element 114 (e.g., to proof mass movable element 202 and/or proof mass support 204 of proof mass element 114). While the technique illustrated in FIG. 6 is primarily described with reference to VBA 101 of system 100, the technique may be applied to any other accelerometer system described herein.

A manufacturing assembly may selectively damage lattice 402A of a first element 302A and lattice 402B of a second element 302A of an accelerometer (e.g., VBA 101) (602). First element 302A may include, but is not limited to, a portion of proof mass element 114. For example, first element 302A may include a portion of proof mass movable portion 202 or a portion of proof mass support 204. First element 302A may be formed from one or more materials including, but is not limited to, quartz, fused silica, or another material configured to form a covalent bond with silicon.

Second element 302B may include, but is not limited to, a portion of resonator 116. In such examples, second element 302B may be formed from a piezoelectric material (e.g., quartz, fused silica). Second element 302B may be formed from a same material as first element 302A. In such examples, CTE values of first and second elements 302A, 302B may be the same or may be substantially similar. In some examples, elements 302 are formed from different materials

First element 302A may define a first surface 306A and second element 302B may define a second surface 306B. The manufacturing assembly may selectively damage first surface 306A and second surface 306B to damage lattices 402A, 402B, respectively. The manufacturing assembly may selective damage lattices 402 via an ultra-short pulse laser, or via ion implantation, or the like. The selectively damaged portions of lattices 402 may be exposed along surfaces 306.

The manufacturing assembly may dispose bonding solution 304 over first surface 306A and second surface 306B (604). Bonding solution 304 may include an alkali solution and/or a hydroxide. Bonding solution 304 may include silicate additives within a fluid solution (e.g., within hydroxide, the alkali solution).

When bonding solution 304 is disposed over surfaces 306, bonding solution 304 may chemically damage elements 302 along surfaces 306. Selectively damaged portions of lattices 402 (e.g., damaged during step 602) may be chemically damaged at a faster rate and/or experience a greater magnitude of damage than undamaged portions 404 of surfaces 306. Damage to lattices 402 may expose atoms 504A, 504B of lattices 402A, 402B, respectively. Atoms 504 may depend on the material used to form the respective elements 302 and may include, but are not limited to, Si atoms or Al atoms.

The manufacturing assembly may dispose bonding solution 304 over second surface 306B of second element 302B to selectively damage second surface 306B (606). Second element 302B may include, but is not limited to, one of resonators 116.

Lattice 402AB may be damaged prior to introduction of bonding solution 304, e.g., via selective laser etching or ion implantation. Exposing lattice 402B may promote damage to lattice 402B (e.g., by bonding solution 304), thereby facilitating selective damage of second surface 306B. When the manufacturing assembly disposes bonding solution 304 over second surface 306B, hydroxide within bonding solution 304 may selective damage exposed portions of lattice 402B. The manufacturing assembly may selectively dispose bonding solution 304 second surface 306B of second element 302B in a same of similar manner as previously described above, e.g., in step 604. When lattice 402B is damaged, atoms 402B forming lattice 402B is exposed, e.g., which may facilitate formation of bond 300.

The manufacturing assembly may place first surface 306A in contact with second surface 306B to form bond 300 between first surface 306A and second surface 306B (608). Once surfaces 306 are placed in contact with each other, additive(s) (e.g., silicates) in bonding solution 304 may interact with atoms 504 in lattices 402 to form bond 300 between surfaces 306. Bond 300 may include, but is not limited to, a hydroxide-catalyzed bond. Bond 300 may have a CTE value less than or equal to CTE values of first element 302A and second element 302B. For example, bond 300 may have a CTE value less than or equal to the CTE value of quartz or of fused silica. The lower CTE value of bond 300 may reduce a strain at or around interface(s) between proof mass element 114 and resonators 116 (e.g., due to different rates of thermal expansion and/or contraction), thereby reducing bias in the accelerometer system.

The manufacturing assembly may place surfaces 306 in contact with each other until bond 300 has been formed. In some examples, the manufacturing assembly may apply heat and/or pressure on surfaces 306, e.g., to accelerate formation of bond 300 between surfaces 306.

Aside from use in accelerometer systems, the techniques described herein may also be used for manufacture of one or more other mechanical systems. The one or more other mechanical systems may include, but are not limited to, ring laser gyroscopes (RLG), micro-electro-mechanical systems (MEMS), or the like.

This disclosure describes the following examples:

Example 1: a proof mass assembly comprising: a proof mass element; and a resonator, wherein the resonator is bonded directed to the proof mass element, wherein the proof mass element has a first coefficient of thermal expansion (CTE), wherein resonator has a second CTE, and wherein a bond between the resonator and the proof mass element has a third CTE, the third CTE being substantially similar to or of lower magnitude than one or more of the first CTE or the second CTE.

Example 2: the proof mass assembly of example 1, wherein the bond comprises a hydroxide-catalyzed bond.

Example 3: the proof mass assembly of any of examples 1 and 2, further comprising a bonding solution disposed over a first surface of the proof mass element and a second surface of the resonator, wherein the bonding solution is configured to interact with the proof mass element and the resonator to form the bond between the first surface and the second surface.

Example 4: the proof mass assembly of example 3, wherein the bonding solution is configured to selectively damage the first surface to expose a first lattice, wherein the bonding solution is configured to selectively damage the second surface to expose a second lattice, and wherein the bonding solution is configured to form the bond between a first plurality of atoms in the first lattice, a second plurality of atoms in the second lattice, and one or more additives in the bonding solution.

Example 5: the proof mass assembly of example 4, wherein the bonding solution comprises: hydroxide; and the one or more additives, the one or more additives comprising a silicate.

Example 6: the proof mass assembly of any of examples 4 and 5, wherein the first surface defines a first selectively damaged portion and a first undamaged portion, wherein the first lattice is exposed along the first selectively damaged portion.

Example 7: the proof mass assembly of example 6, wherein the first selective damaged portion is damaged by one or more of an ultra-fast laser or ion implantation prior to disposal of the bonding solution over the first surface.

Example 8: the proof mass assembly of any of examples 1-7, wherein the bond comprises a Si—O—Si bond.

Example 9: the proof mass assembly of any of examples 1-8, wherein the bond between the resonator and the proof mass element defines a thickness of about 100 nanometers (nm).

Example 10: the proof mass assembly of any of examples 1-9, wherein one or more of the proof mass element or the resonator comprises a fused silica.

Example 11: a method comprising: selective damaging, via one or more of an ultra-fast laser or ion implantation, a first outer surface of a first component of a proof mass assembly and a second outer surface of a second component of the proof mass assembly to selective damage a first lattice of the first component and a second lattice of the second component; disposing a bonding solution over the first outer surface and the second outer surface, wherein the bonding solution comprises a hydroxide and one or more additives; placing the first outer surface in contact with the second outer surface; and forming, via the one or more additives in the bonding solution, a bond between a first selectively damaged portion of the first lattice and a second selectively damaged portion of the second lattice, wherein the first element has a first coefficient of thermal expansion (CTE), wherein the second element has a second CTE, wherein the bond has a third CTE, and wherein the third CTE is less than or equal to one or more of the first CTE or the second CTE.

Example 12: the method of example 11, wherein the one or more additives comprises a silicate.

Example 13: the method of any of examples 11 and 12, wherein the bond comprises a hydroxide catalyzed bond.

Example 14: the method of any of examples 11-13, wherein the bond comprises a Si—O—Si bond.

Example 15: a proof mass assembly comprising: a proof mass element comprising: a proof mass movable portion; and a proof mass support coupled to the proof mass movable portion; and a resonator extending from a first end to a second end; wherein the first end of the resonator is bonded directly to the proof mass movable portion via a first bond, wherein the second end of the resonator is bonded directly to the proof mass support via the second bond, wherein the proof mass element has a first coefficient of thermal expansion (CTE), wherein the resonator has a second CTE, and wherein the each of the first bond and the second bond has a third CTE, the third CTE being less than or equal to one or more of the first CTE or the second CTE.

Example 16: the proof mass assembly of example 15, wherein the first bond is configured to affix a first selectively damaged lattice of the first end of the resonator to a second selectively damaged lattice of the proof mass movable portion, and wherein the second bond is configured to couple a third selectively damaged lattice of the second end of the resonator to a fourth selectively damaged lattice of the proof mass support.

Example 17: the proof mass assembly of example 16, wherein one or more of the first selectively damaged lattice, the second selectively damaged lattice, the third selectively damaged lattice, or the fourth selectively damaged lattice is selectively damaged by one or more of an ultra-fast laser or ion implantation.

Example 18: the proof mass assembly of any of examples 15-17, wherein each of the first bond or the second bond comprises a Si—O—Si bond.

Example 19: the proof mass assembly of any of examples 15-18, wherein a bonding solution is disposed on the first end of the resonator to form the first bond, wherein the bonding solution is disposed over the second end of the resonator to form the second bond, and wherein the bonding solution comprises: hydroxide; and a silicate.

Example 20: the proof mass assembly of any of examples 15-19, wherein a first lattice of the first end of the resonator is selectively damaged by an ultra-fast laser prior to disposal of the bonding solution over the first end, and wherein a second lattice of the second end of resonator is selective damaged by the ultra-fast laser prior to disposal of the bonding solution over the second end.

In one or more examples, the accelerometers described herein may utilize hardware, software, firmware, or any combination thereof for achieving the functions described. Those functions implemented in software may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure.

Instructions may be executed by one or more processors within the accelerometer or communicatively coupled to the accelerometer. The one or more processors may, for example, include one or more DSPs, general purpose microprocessors, application specific integrated circuits ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for performing the techniques described herein. Also, the techniques could be fully implemented in one or more circuits or logic elements.

The techniques of this disclosure may be implemented in a wide variety of devices or apparatuses that include integrated circuits (ICs) or sets of ICs (e.g., chip sets). Various components, modules, or units are described in this disclosure to emphasize functional aspects of devices configured to perform the disclosed techniques, but do not necessarily require realization by different hardware units. Rather, various units may be combined or provided by a collection of interoperative hardware units, including one or more processors as described above, in conjunction with suitable software and/or firmware.

What is claimed is:

1. A proof mass assembly comprising:
a proof mass element; and
a resonator,
wherein the resonator is bonded directed to the proof mass element,
wherein the proof mass element has a first coefficient of thermal expansion (CTE), wherein resonator has a second CTE, and wherein a bond between the resonator and the proof mass element has a third CTE, the third CTE being substantially similar to or of lower magnitude than one or more of the first CTE or the second CTE.

2. The proof mass assembly of claim 1, wherein the bond comprises a hydroxide-catalyzed bond.

3. The proof mass assembly of claim 1, further comprising a bonding solution disposed over a first surface of the proof mass element and a second surface of the resonator, wherein the bonding solution is configured to interact with the proof mass element and the resonator to form the bond between the first surface and the second surface.

4. The proof mass assembly of claim 3, wherein the bonding solution is configured to selectively damage the first surface to expose a first lattice, wherein the bonding solution is configured to selectively damage the second surface to expose a second lattice, and wherein the bonding solution is configured to form the bond between a first plurality of atoms in the first lattice, a second plurality of atoms in the second lattice, and one or more additives in the bonding solution.

5. The proof mass assembly of claim 4, wherein the bonding solution comprises:
hydroxide; and
the one or more additives, the one or more additives comprising a silicate.

6. The proof mass assembly of claim 4, wherein the first surface defines a first selectively damaged portion and a first undamaged portion, wherein the first lattice is exposed along the first selectively damaged portion.

7. The proof mass assembly of claim 6, wherein the first selective damaged portion is damaged by one or more of an ultra-fast laser or ion implantation prior to disposal of the bonding solution over the first surface.

8. The proof mass assembly of claim 1, wherein the bond comprises a Si—O—Si bond.

9. The proof mass assembly of claim 1, wherein the bond between the resonator and the proof mass element defines a thickness of about 100 nanometers (nm).

10. The proof mass assembly of claim 1, wherein one or more of the proof mass element or the resonator comprises a fused silica.

11. A method comprising:
selective damaging, via one or more of an ultra-fast laser or ion implantation, a first outer surface of a first component of a proof mass assembly and a second outer surface of a second component of the proof mass assembly to selective damage a first lattice of the first component and a second lattice of the second component;
disposing a bonding solution over the first outer surface and the second outer surface, wherein the bonding solution comprises a hydroxide and one or more additives;
placing the first outer surface in contact with the second outer surface; and
forming, via the one or more additives in the bonding solution, a bond between a first selectively damaged portion of the first lattice and a second selectively damaged portion of the second lattice,
wherein the first element has a first coefficient of thermal expansion (CTE), wherein the second element has a second CTE, wherein the bond has a third CTE, and wherein the third CTE is less than or equal to to one or more of the first CTE or the second CTE.

12. The method of claim 11, wherein the one or more additives comprises a silicate.

13. The method of claim 11, wherein the bond comprises a hydroxide catalyzed bond.

14. The method of claim 11, wherein the bond comprises a Si—O—Si bond.

15. A proof mass assembly comprising:
a proof mass element comprising:
a proof mass movable portion; and
a proof mass support coupled to the proof mass movable portion; and
a resonator extending from a first end to a second end;
wherein the first end of the resonator is bonded directly to the proof mass movable portion via a first bond, wherein the second end of the resonator is bonded directly to the proof mass support via the second bond,
wherein the proof mass element has a first coefficient of thermal expansion (CTE), wherein the resonator has a second CTE, and wherein the each of the first bond and the second bond has a third CTE, the third CTE being less than or equal to one or more of the first CTE or the second CTE.

16. The proof mass assembly of claim 15, wherein the first bond is configured to affix a first selectively damaged lattice of the first end of the resonator to a second selectively damaged lattice of the proof mass movable portion, and wherein the second bond is configured to couple a third selectively damaged lattice of the second end of the resonator to a fourth selectively damaged lattice of the proof mass support.

17. The proof mass assembly of claim 16, wherein one or more of the first selectively damaged lattice, the second selectively damaged lattice, the third selectively damaged lattice, or the fourth selectively damaged lattice is selectively damaged by one or more of an ultra-fast laser or ion implantation.

18. The proof mass assembly of claim 15, wherein each of the first bond or the second bond comprises a Si—O—Si bond.

19. The proof mass assembly of claim 15, wherein a bonding solution is disposed on the first end of the resonator to form the first bond, wherein the bonding solution is disposed over the second end of the resonator to form the second bond, and wherein the bonding solution comprises:
hydroxide; and
a silicate.

20. The proof mass assembly of claim 15, wherein a first lattice of the first end of the resonator is selectively damaged by an ultra-fast laser prior to disposal of the bonding solution over the first end, and wherein a second lattice of the second end of resonator is selective damaged by the ultra-fast laser prior to disposal of the bonding solution over the second end.
